(19) United States
(12) Patent Application Publication
(10) Pub. No.: US 2003/0137435 A1
(43) Pub. Date: Jul. 24, 2003

(54) Alerting users to impending events

(76) Inventors: Wassim Haddad, Bristol (GB); John Lawrence, Birmingham (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/300,006

(22) Filed: Nov. 20, 2002

(30) Foreign Application Priority Data
Nov. 20, 2001 (GB) 0127730.0

(51) Int. Cl. G08G 1/123

(52) U.S. Cl. 340/994

(57) ABSTRACT

A user is alerted to an expected occurrence of an event and automatically provided with a predetermined notice period of the expected occurrence of the event by identifying an event having an unreliable start time, but a start time that can be predicted more accurately as the time of the event approaches by monitoring a precursor parameter to the event. By monitoring the precursor parameter, a prediction is made of when the event is likely to occur. Advance notice that the event is expected to take place is automatically issued during a predetermined notice period before the expected time of the event. Session Initiation Protocol communicates the advance notice.

### FIELD OF THE INVENTION

This invention relates to alerting users to impending events. In particular, but not exclusively, it relates to alerting users that a vehicle is about to arrive at a location, or depart from a location.

### BACKGROUND TO THE INVENTION

Many forms of mechanical transport have a scheduled timetable for their route, detailing when they are expected to arrive at predetermined stops on their route. Examples include buses, trains, and aeroplanes. It is convenient to use buses as an example. A bus may be expected to arrive at a certain bus stop at a certain time, but they are often late. Worse still, they are sometimes early. This means that a prudent bus passenger has to arrive at their embarkation bus stop a few minutes early, in case the bus arrives early, but they will not be surprised to wait several minutes past the scheduled arrived time for the bus. Sometimes a particular bus is cancelled, or experiences mechanical failure, or is delayed significantly, and the would-be passenger has to wait for the next bus. Thus it is not unknown for a passenger to arrive at their bus stop five minutes before the scheduled time of arrival for the bus, but have to wait, say, thirty five minutes because the bus they intended to catch did not turn up and they had to wait for the next one (scheduled to be thirty minutes later). This is annoying and wasteful of the passenger's time, even in good weather. In bad weather it is even more annoying for the passenger.

There are also other occasions where the unpredictable timing of an event can cause difficulties for people. For example, waiting for a taxi to arrive leaves the customer wondering whether they have two minutes to go, or fifteen minutes. Waiting for the arrival of a goods vehicle to deliver goods, or to take them away, also often leaves the person waiting wasting time. In the case of waiting for a consignment of goods to be collected the user also does not really know whether they can finish the goods off at leisure (because the vehicle will-be late), or-whether they have to rush to finish the consignment so that it is ready at, or even before, the scheduled collection time. If there are a number of different consignments awaiting different vehicles the user does not know which vehicle will arrive first, and so cannot place the assignments in a logistically useful order relative to a loading bay. Another category of examples relates to non-vehicular events which nevertheless have a less than fully predictable start time. For example, it can be frustrating waiting for a performance to begin (e.g. theatre, cinema etc); extra minutes spent doing something more pleasurable than queuing may be attractive to some people.

It is an aim of at least one embodiment of the present invention to ameliorate at least some of the above difficulties.

U.S. Pat. No. 5,736,940 discloses a radio frequency portable bus information unit which receives bus position signals from a Transit Control Computer (TCC). The portable unit has the functionality necessary to convert bus position signals from the TCC to predicted time to arrival information visually presented to the user on a display. A beeper may also give a user advance warning of the arrival of a bus travelling along a specified route at a specified stop. In order to have the beeper sound the passenger is required to have the portable received turned on and the stop and route of choice displayed, and the beeper request in the “on” state. Stored beeper alerts remain dormant until the passenger chooses to activate them by turning the beeper status to “on” for the stop/route. The receiver also receives fare information.

WO 98/14926 discloses a system for providing the home telephones of school bus users with an advance warning telephone call that the school bus is coming. An on-board vehicle control unit (VCU) of a school bus determines the position of the bus and communicates it, via a cellular phone link, to a Base Station Control Unit (BSCU) which estimates the time of arrival of the bus at the homes of-school bus riders. The BSCU telephones the land-line home telephone of school bus riders an advance warning. It is possible to register for the list of school bus riders over the telephone, and to change the advance notice period over the telephone. The BSCU knows the list of registered school bus riders and their home telephone numbers and the advance notice they require, and has input to it by the VCU the position of the school bus, and telephones the home telephones to give advance warning.

WO 98/40837 discloses a package delivery system for providing a persons PC with advance notice of the arrival of a vehicle (e.g. a courier package vehicle). Vehicles have Vehicle Control Units (VCU) in them which use GPS or the like to estimate the position of the vehicle, and transmit vehicle-position information to a Base Station Control Unit (BSCU). This communicates via a computer network with a user's PC. The BSCU or the user's PC can convert vehicle position data into time of arrival/data. The user's PC can be used to enter personal preferences for the length of advance notice required. The user's PC may contact the user by telephone. In a variant, the user enters their warning period choice via their PC and the BSCU may telephone a user's telephone, possibly mobile telephone, with advance warning of a delivery in addition to contacting their PC. The VCU allows the driver of the vehicle to enter data to the BSCU which can be used to predict expected arrival times at specific drop off/pick-up points.

WO 94/27264 discloses a system for notifying a land-line telephone of a passenger for a school bus with advance notification that the bus is arriving. The position of the bus is determined using GPS or land based sensors and a time-before-arrival is calculated. A central station computer has previously had entered into it details of the locations and telephone numbers of the expected school bus riders and sends advance warning telephone calls to the usual riders a set time before the predicted arrival of the bus. The control station is a central station with manual initial set up of the input of expected rider addresses, and telephone numbers, and a standard, common for all, warning time period. Each school bus rider also has a magnetic I.D. card to identify themselves to the bus when they embark.

### SUMMARY OF THE INVENTION

According to a first aspect the invention comprises a method of alerting a user to the expected occurrence of an event and of automatically providing the user with a predetermined notice period of the expected occurrence of the event, the method comprising:

identifying an event which has an unreliable start time, but a start time that can be predicted more accurately as the time of the event approaches by monitoring a precursor parameter to the event;

predicting from the monitoring of the precursor parameter when the event is likely to take place;

automatically issuing advance notice that the event is expected to take place, the advance notice being issued a predetermined notice period before the expected time of the event, and using Session Initiation Protocol to communicate the advance notice.

Thus an automatic warning is produced, alerting users to the impending event a suitable time beforehand. This enables a user to plan their time more carefully in the closing stages before the event.

Preferably the advance notice is issued at least in part via electronic telecommunication, possibly via wireless telecommunications (for example via a mobile telephone, mobile PDA, or lap top computer). The notice may be transmitted by wired telecommunication, or by a mixture of wired and wireless telecoms, or substantially entirely by wireless telecommunication.

The precursor parameter comprises something that changes as the event draws near in time. For example, if the event is the arrival of a vehicle at a specified location the precursor parameter may be, for example, the position of the vehicle (or the distance of the vehicle from the specified location, or the estimated time it will take the vehicle to arrive at the predetermined location based on the position of the vehicle).

A user may be able to select the length of time they require as advance notice of the event.

A user may be able to select certain events about which they require advance notice, possibly effectively deselecting other events about which they will not be alerted in advance. The advance notice period may be selectable only as between predetermined set notice periods. For example a user may be able to select a notice period from the group: n minutes, 15 minutes, 14 minutes, 13 minutes, 12 minutes, 11 minutes, 10 minutes, 9 minutes, 8 minutes, 7 minutes, 6 minutes, 5 minutes, 4 minutes, 3 minutes, 2 minutes, 1 minute, but not be able to select sub divisions of a minute (i.e. no seconds).

The method may comprise transmitting an advance notice signal to a plurality of users simultaneously, or substantially simultaneously. The method may comprise having a flag associated with the broadcast signal and having a user device recognise flags which are associated with events for which it is intended to provide an advance notice warning to its user. The advance notice signal may comprise a telecast signal. Thus the user's device may be able to filter out unwanted signals and pass only wanted advance notice signals. The user may be able to select or set the filter on their telecommunications device themselves, and may be able to change the profile of the filter as they desire (within the design parameters of the device).

In one preferred embodiment the event comprises the arrival or departure of a vehicle at a specified location. The specified location may be a predetermined, fixed, stopping point, or vehicle stop, for the vehicle (e.g. a bus stop, train station, airport, taxi rank). Alternatively the specified location may not be so predetermined, but could be a more variable predetermined specified location (e.g. any house or location to which a taxi is to arrive).

The user may be able to specify how they wish to be notified of the expected event. For example they may be able to specify the electronic address, or device, to which the notification is to be sent (for example their mobile telephone phone, their home land-line wired telephone, their office telephone, their PC (fixed or mobile), a PDA etc. They may also be able to specify or select how their device will alert them, for example by audio (e.g. buzzer, ring, voice) or visually (e.g. flashing light, text message, graphically) or in some other way (e.g. vibrating device), in addition to or instead of being able to specify the device to which the message will be sent.

When the event is to take place at a specific location the method may comprise, preferably automatically, monitoring the position of the user's device and modifying the timing of the alert notice depending upon how long it is estimated that the user will take after receiving the alert notice to reach the specific location at which the event will take place.

The user may not have to select a desired notice period: the system may have a default, or fixed, setting. Even if there is an initial notice period set by the user or system this may be modified. It may be modifiable by the user, and/or it may be modified if the user moves significantly further from the specific location of the event (or possibly even if they move closer to it). As an example, if the user initially selects or sets a 10 minutes warning when they are at location A, which is estimated to be 4 minutes walk from the location of the event, and the user then moves to location B which is estimated to be 8 minutes walk from the location of the event, the notice period may be changed automatically to a 14 minute warning—i.e. the notice period has changed in time with the increased expected travel time for the person to get to the site of the event, in comparison with the expected travel time from the position of the person when the advance notice period was originally set.

A further feature of some, but not all, embodiments of the invention is that other parameters or factors that affect the timing of an appropriate early warning alert signal can be used to modify the timing of the alert signal, beyond (as well as or instead of) subsequent variation in distance between the user and the site of the event. For example, if it was known that traffic was bad in a particular stretch of road, the weather was bad (typically slows vehicular traffic), or that there was some other predicted slow down in the time expected for the event to occur from an earlier determined point (e.g. baggage handlers dispute at an airport, leaves on the line for a railway, service is short staffed generally), then even though it might “normally” take a certain time to go between an earlier predicted point 1, or precursor event 1, and the watched-for/wanted event or place 2, then due to adverse circumstances it may be possible to predict a slower than normal progress between “1” and “2”, and so the timing of the issuance of the alert signal may be retarded to compensate: so that the factor which influences the time between precursor event or position “1” and event or place “2” is compensated for in order to keep the prediction of when event “2” will occur more accurate in comparison to circumstances where no compensation were to be applied.

A further feature of some, but by no means all, embodiments is that if users waiting for an event register their device for an early notice alert the system may be able to predict, possibly automatically, expected demand for the event. This may enable further event resources to be made available (possibly with automatic signalling of the need for further resources). For example, if a bus company knows that there are more people waiting for a specific bus than it can accommodate (allowing for typical patterns of usage—when and where people get on and off), it is possible for the bus company to run another bus, or divert a bus from a less busy route to a busy route. Similar comments apply to trains and other vehicles. In the case of non-vehicular applications it can be seen that if a restaurant, for example, knows it has too many people waiting for tables it can decide to open up a spare/reserved room in order to accommodate them, and/or advise potential future customers of the difficulty.

The number of users waiting for an alert call can provide a resource usage prediction figure, which in turn can be used to influence future things, such as a dynamic pricing structure (e.g. making things more expensive or less expensive depending upon actual or predicted usage) and/or altering the amount of resources available.

According to a further aspect the invention comprises a method of alerting a user of the approach of a vehicle comprising:

having details of the identity of at least one vehicle, the stops that it is intended to make, and the amount of time required for an advance warning to the user notifying them that a vehicle is due at a selected stop;

monitoring the progress of the or each vehicle along its route;

predicting how long it will take the or each vehicle to reach the or each vehicle stop using the present position of the vehicle information;

determining when the vehicle reaches a distance from the stop predicted to take substantially the same time as the required advance warning time, and

alerting the user to the approach of the vehicle when the expected time for it to travel to the stop is substantially the same as the required advance warning time;

wherein the user is alerted by a Session Initiation Protocol telecommunications signal.

By “vehicle” it will be understood that any vehicle is intended, including, but not limited to: buses, trains, aeroplanes, automobiles (e.g. taxis), lorries, ships, etc.

A database having parameters representative of one or more of the above may be created.

Preferably there are a plurality of vehicles (e.g. buses). The or each vehicle (e.g. bus) may have a route comprising a plurality of different bus (or other vehicle) stops. More than one classification or route of vehicle may stop at the same vehicle (e.g. bus) stop.

There may be a plurality of users, possibly of the order of several, tens, hundreds, thousands, or more. The method may comprise telecommunicating an alert signal to a user, possibly via telephone (land-line or wireless), PC, (portable or fixed) PDA, or portable electronics device, or other electronic device. The alert signal may comprise an audio message, such as a voice message, or a buzzer or bell, and/or a visual message, for example a text message (e.g. SMS or e-mail), or a flashing light. WAP telephone technology may be used, or piconet technology (e.g. Bluetooth or 802.11).

The method may comprise communicating the alert signal from a base station (e.g. a bus station, train station, airport, shipping port) to the user, or the signal may be communicated from a vehicle to the user. The base station may be fixed or mobile and may be provided in or on a vehicle (e.g. bus).

The or each bus (or other vehicle) preferably communicates its location to a control processor which uses the location of the or each vehicle to establish when to alert the user that a specified vehicle is coming. The control processor may be located at the base station.

The method may comprise the user communicating to an alert generator one or more of:

(i) the identity of the bus stop (or vehicle stop) at which they wish to meet the bus (or vehicle);

(ii) the approximate time at which they wish to catch the vehicle;

(iii) the identity of the vehicle (e.g. bus) they wish to catch and/or the route and/or their destination;

(iv) the amount of notice time they would like to have as an early warning that the vehicle is due for arrival at the vehicle stop.

In some embodiments the user inputs all of the above. In others, for example, there may be no provision for not alerting the user to the impending presence of buses (or other vehicles) of the correct route but that are too early (i.e. if the user does not want to catch the next bus (or other vehicle), but rather a subsequent bus. Alternatively or additionally there may be no provision for a user-selected notice/alert period: the system may give a standard, fixed, notice period as an alert.

The position of the bus or other vehicle (which translates into an expected time of arrival of the bus or vehicle at a selected vehicle stop) may be monitored in any convenient way. Global Positioning Satellite systems may be suitable to locate the vehicle or vehicles. Roadside transponders may be suitable to locate the position of road going vehicles (e.g. buses). Roadside transponders may possibly communicate the position of the vehicle to the base station—alternatively a roadside transponder could tell the vehicle where it is and the vehicle could communicate its position to the base station. The vehicle may have an inertial navigation system, which may provide signals relating to, for example, speed of the bus and direction of the bus, which when overlaid onto a route map for the bus could be used to establish the position of the bus or other vehicle. The calculations could be performed on the vehicle or remote from the vehicle.

The method may comprise the user selecting one or more vehicles (e.g. buses) about which he wishes to be informed. The user may have a telecommunications device which filters out, or does not react to, received signals relating to non-selected buses (or other vehicles) and which only alerts the user to events relating to the selected vehicle or vehicles. The user may input the selection of which vehicle is of interest, possibly using the same device which alerts them to the impending arrival of a bus. The device may be portable, and may be hand-held.

It will be appreciated that the invention is applicable to other forms of transport beyond buses which have unpredictable arrival and/or departure times. For example, trains and train stations can take the part of buses and bus stations. Aeroplanes and airports can take the part of buses and bus stations. Transport, preferably (but not necessary) with a schedule and preferably, (but not necessarily) fixed stopping points can use the present invention. It is also possible for a user to be given advance notice of the arrival of non route-fixed transport, such as, a taxi or car: if the position of the vehicle is known and the pick up point known, an advance notice signal can be generated a suitable time before the car arrives.

Indeed, the invention is not necessarily limited to transport. There are other occasions when the timing of an event is not accurately predictable too far in advance, but which becomes more predictable as the event approaches in time, and for which advance notice would be desirable.

Examples include: being alerted when a table in a restaurant is about to become free (the restaurant staff would have to enter this fact into their transmitter); being alerted when a performance is about to start (e.g. theatre performance, cinema performance, sporting performance, or even TV performance).

According to another aspect the invention comprises a system adapted to provide an early warning alert to a user of the expected occurrence of an event, the system comprising:

a notice alert generator adapted to generate an alert notice;

a user-operated input device adapted to input a request for a notice alert to be sent;

an alert notice emitter adapted to emit an alert notice signal;

an alert notice detector adapted to detect an alert notice signal;

a user alarm adapted to produce a user-noticeable alert alarm;

the arrangement being such that in use the user is capable of requesting a notice alert using the input device, the alert notice generator, in use, receiving the alert notice request and producing an alert notice in response to the request, the alert notice being emitted by the emitter and detected by the detector, thereby causing the user to be alerted; and the alert notice is communicated to the user using Session Initiation Protocol telecommunications.

The input device may have associated with it, in a single device, the alert notice detector and/or the user alarm. The alert generator may have associated with it at the same site, possibly as part of a single device, the alert notice emitter.

Preferably the alert notice generator generates the alert notice at a time that is dependent upon the alert notice request. The input device may have a notice period selector which is adapted to enable a user to select a desired notice period so that a user is, in use, alerted the selected length of time before the event is expected to occur.

The system may include an event precursor monitor which, in use, monitors a parameter which is useful in predicting when the event will take place, and which provides event precursor parameter signals to the alert notice generator.

The event precursor parameter may comprise, or be related to, the physical location of a mobile object (e.g. the position of a vehicle), in which case the event precursor monitor may be an object locating or position determining system adapted to evaluate the location of a selected object.

The input device may have event-selection means to enable the user to select one or more events for advance notice alert alarm production by the user-noticed alarm. The user may be able to select from an allowable set of events.

The alert generator and/or alert notice emitter may be provided in a vehicle station, such as a bus or train station, as may be the event precursor monitor.

The alert notice detector and the user alarm may be provided on a user device, such as a portable hand-carriable wireless telecommunications device, for example a mobile telephone, portable computer or personal digital assistant.

A vehicle, e.g. a bus, could carry a transponder identifying its geographical position and/or identify itself to the event precursor monitor.

An algorithm operating in the alert generator, which may comprise a microprocessor, may operate upon the selected vehicle identity (or vehicles identities), the advance warning time to be given, the position of the vehicle, and the position of the vehicle stop, to generate an advance notice alert a predetermined time before the vehicle is expected to arrive at the stop. The user may input the advance warning time to be given.

According to another aspect the invention comprises software which when running on a processor configured to function as an advance notice alert generator, takes as input parameters: the selected event; a precursor parameter related to the selected event to enable the timing of the selected event to be predicted; and a notice period length of time representative of the amount of time before the selected event a user wishes to be informed of the impending arrival of the event; and which operates on the inputs to generate a Session Initiation Protocol alert signal at a time before the predicted event that is predicted to be the desired notice period before the event is expected to take place, and to output the Session Initiation Protocol alert signal to a telecommunications transmitter.

The software is preferably provided on a machine readable data carrier such as a disc or solid state chip.

The software may also be adapted to output a notice alert signal to a telecommunication transmitter.

The software may also be adapted to label the notice alert signal with a flag to enable those users who have elected to receive signals carrying that flag to identify the notice alert signal as a desired, flagged, signal. The flag may comprise a portion representative of the type of event (e.g. which bus number) and/or the location of the event (e.g. which bus stop).

According to a further aspect the invention comprises software which when running upon a processor enables the processor to generate an output signal representative of one or more of:

(i) a user-selected advance notice alert period;

(ii) an event-identifying label or signal;

(iii) an event timing label or signal; and

(iv) an address to receive an alert label or signal.

The event-identifying label or signal (ii) may include a type of event label or signal (e.g. which has number/route or which bus or train destination) and/or a location-identifying label or signal (e.g. which bus stop or train station, or platform).

The event timing label or signal may comprise an approximate time around which it is desired to be notified of qualifying or selected events, or after which it is desired to be notified of events (e.g. “buses” which depart after 10.00 p.m., or about 10.00 p.m., for example ±15 minutes, or earlier than with a short period before the input target time).

The address label or signal may specify to what electronic telecomms device the alert signal is to be addressed, when it is created and transmitted.

The software may convey the physical or geographical location of the user's device in the output signal.

The software may include a user-device movement compensatory function which evaluates whether the user device has moved significantly geographically after a request for an alert warning signal has been transmitted by the user device, and if so causes an updated/modified advance warning period to be set to take into account the movement of the user.

According to another aspect the invention comprises:

a server having a control processor and a database, the database having details of the addresses of user devices, the location of an event site, an early warning alert period that it is intended to give to specific users as an early warning of the-expected arrival of-respective selected events; and the

processor having access to event alert notice generator software which has as an input an event precursor parameter which changes as the event approaches in time, and wherein the processor is adapted to use the event alert notice generator software to process the event precursor parameter in conjunction with the data in the database to generate an alert advance notice signal at a time that is predicted to be the desired notice period before the event is expected to occur, the alert advance notice signal being generated in a form communicatable with a remote device using Session Initiation Protocol telecommunications.

The event precursor parameter may be the position of vehicle, such as a bus, or may be derived from the position of a vehicle.

The software may evaluate the expected time of arrival of a vehicle at a selected stop and compare that with the notice period, and may issue the alert signal when they are equal or substantially equal.

According to another aspect the invention comprises a computer readable memory device encoded with a data structure for generating advance notice of an impending event, the data structure having entries, each entry containing a first parameter value corresponding to the telecommunications address of each user, a second parameter value corresponding to the chosen event for which each user is to receive advance notice, and a third parameter value corresponding to the amount of advance notice time each user requires.

Possibly the data structure may include a fourth parameter value corresponding to a monitored event precursor useable in the prediction of the time of the event.

According to another aspect the invention comprises a hand held portable wireless telecommunications device having a control processor, a transmitter and receiver, a data input structure, and a program store; the data input structure allowing data to be input into the device, and the control processor having access to an event notification program stored on the program store, the event notification program being adapted to prompt in use, the input of data relating to one or more of: (i) the identity of an event for which advance notice is required, (ii) the amount of time required as advance notice; and the device being adapted to emit a signal containing the input prompted data.

The device may have a position sensor and may be adapted to include in the emitted signal data relating to its position. The device may be adapted to prompt the input of data relating to the identity of a specific vehicle and/or the identity of a specific location at which the vehicle is to stop. Perhaps the device need not be wireless and/or hand held and/or portable.

By “general purpose” portable wireless telecommunications device is meant a device which is not just dedicated to receiving information relating to the event and/or inputting requests to be notified of the event: a device which has wider telecommunications capabilities including, typically, at least one of: voice telecommunications; e-mail telecommunications; internet access; SMS telecoms; video telecoms.

Many general purpose mobile wireless telecoms devices will be able to provide more than one from the above list. For example, both voice and some form of graphic telecoms. A mobile telephone, for example a WAP phone, or a 3G phone, would be suitable as a general purpose portable wireless telecoms device, as would a PDA with e-mail facility and/or internet access facility.

### BRIEF DESCRIPTION OF THE DRAWINGS

Embodiments of the invention will now be described by way of example only, with reference to the accompanying drawings of which:

FIG. 1 shows schematically a bus arrival notification system;

FIG. 2 shows the arrangement of FIG. 1 even more schematically;

FIG. 3 shows a mobile telephone for use with the system of FIGS. 1 and 2;

FIG. 4 shows a schematic representation of data in a database of the system of FIGS. 1 and 2;

FIG. 5 shows an alternative bus to those shown in the system of FIGS. 1 and 2;

FIG. 6 shows an alternative bus of an alternative system;

FIG. 7 shows detail of the system of FIGS. 1 and 2;

FIG. 8 shows a schematic representation of a control processor arrangement similar to that of the system of FIGS. 1 and 2;

FIGS. 9 and 10 shows schematically processes for creating a warning message database and using the warning message database respectively;

FIG. 11 shows a process schematic for the control processor of FIGS. 1 and 2; and

FIG. 12 shows a process flow chart as perceived by a user/passenger of the system of FIGS. 1 and 2.

### DESCRIPTION OF THE PREFERRED EMBODIMENTS

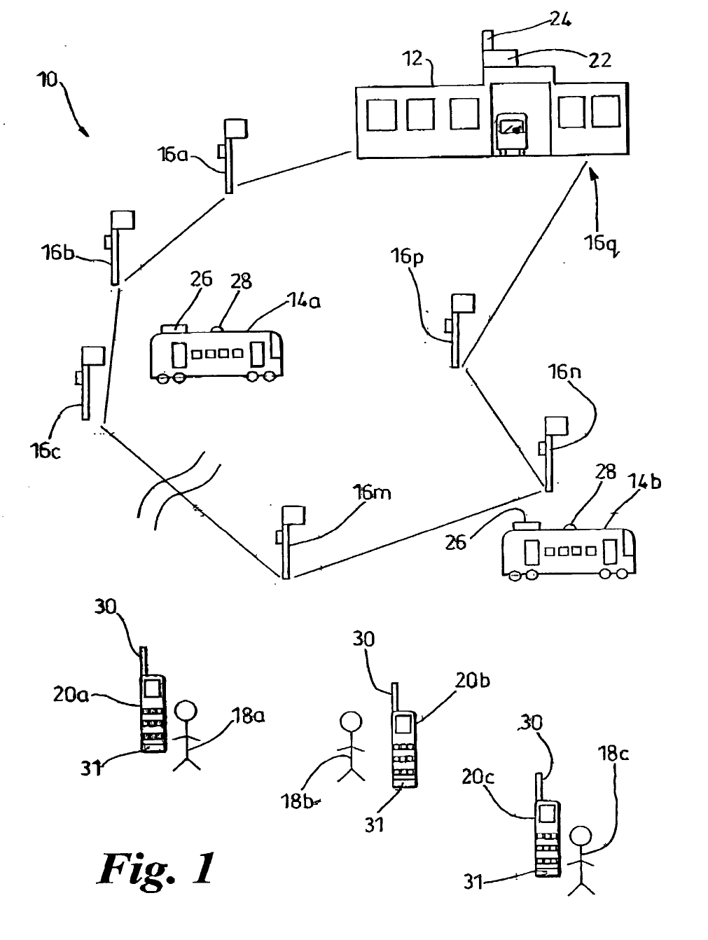

FIG. 1 shows a system 10 for producing an early warning advance alert, or notice, to a prospective bus passenger, or an actual bus passenger, that a bus is about to arrive at a selected bus stop: i.e. that the bus they are waiting for is about to arrive, or that the bus they are actually on is about to arrive, at a selected bus stop. The system comprises a bus station 12, a number of buses 14a, 14b, 14c . . . 14m (only two of which are shown), a number of bus stops 16a, 16b, 16c . . . 16n (only some of which are shown), and a number of passengers 18a, 18b, 18c . . . 18x (only three of which are shown), each with a mobile wireless telecommunications device, in this example a mobile phone, referenced 20a to 20x (only three of which are shown). The bus station 12 has a control processor assembly 22, and a transmitter and receiver assembly 24. The buses 14 have a transmitter 26 and a location finder 28. The mobile telephones have antennae 30 and position sensors 31.

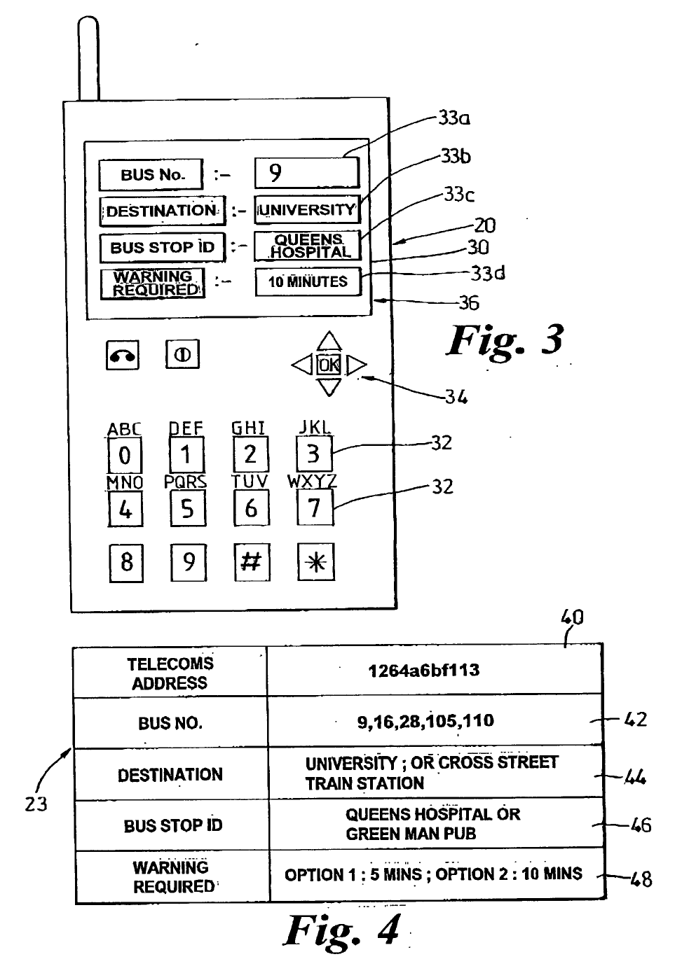

As seen in FIG. 3, the mobile phones 20 have a display screen 30, input keys 32, and navigator buttons 34.

A user 18 who wishes to be informed in advance when a particular bus is expected to arrive at a particular bus stop enters his request for an early warning alert alarm into the processor 22 using their mobile phone 20. They activate advance notice software on their mobile phone (e.g. by entering a code, or by moving an active cursor or screen region to an appropriate icon on a menu screen of their mobile phone) and the telephone displays a request form, referenced 36 in FIG. 3, on the screen 30. The user completes the request form and sends the data to the processor 22 via the telecommunication antenna 30 of the phone. For example, as shown in FIG. 3 the user may be asked for the route number of the bus they wish to be notified of (in this example the user has keyed in, using keys 32, route “9” into a first data input field 33a).

The user then presses “enter”, or “OK”, or shifts down to the next box or field 33b displayed, using the navigator keys 34. Another item of information is required to be entered: the destination. In this example the user enters “University” using the keys 37. In an alternative embodiment a menu may appear allowing the user to select a chosen destination/disembarkation stop from a menu of possible locations at which the selected bus stops. In another embodiment the user may not be asked for a destination, or may choose not to complete that field.

The user navigates to the next field, field 33c, which is for the answer to the next prompt or question, which relates to the identity of the bus stop which the user wishes to know when the bus will be arriving (i.e. usually the stop at which the user wishes to catch the bus). In this example the user has entered “Queens Hospital”. Again, this may be done via keys 32, or via keys 34, possibly in response to selecting from a possible menu of options (e.g. a drop down or expand up box). The user enters the selected bus stop to which they want the early warning to relate and progresses to field 33d which relates to how much time they want as an early warning that the bus will be at their selected bus stop. They then enter the notice period required, in this example 10 minutes. This is typically entered using keys 32, but it could be from up or down keys (indeed any entry may be made by stepping through possible options until the desired option is displayed).

The user then sends their request off to the control processor 22 via the telephone's cellular, or other wireless, link.

The processor 22 has a data base 23 of entries, schematically represented in FIG. 4, linking telecommunications address 40 of user telecoms devices, the bus numbers that the user wishes to be alerted to (referenced 42), optionally the desired destination 44, the embarkation bus stop 46, and the desired warning period 48. In the example shown in FIG. 4 the user wishes to board a bus at either the Queens Hospital stop or alternatively the Green Man Pub stop (both bus stops are a convenient walk from their house, for example), and travel to either the University stop, or the Cross Street train station stop (typically either destination, referred 46 in FIG. 4, is close enough to the user's office which is the user's eventual destination). For example bus routes 9, 16, and 28 may all go from the Queens Hospital stop to the University stop, and bus routes 105 and 110 may go from the Green Man Pub bus stop to the Cross Street Train Station. The database shows two alternative notice periods have been entered into the database at 48; 5 minutes (a first period) for one travel option, and a second period (10 minutes) for the second travel option. This is to reflect the fact that the user is closer to the Queens Hospital bus stop than they are to the Green Man Pub bus stop.

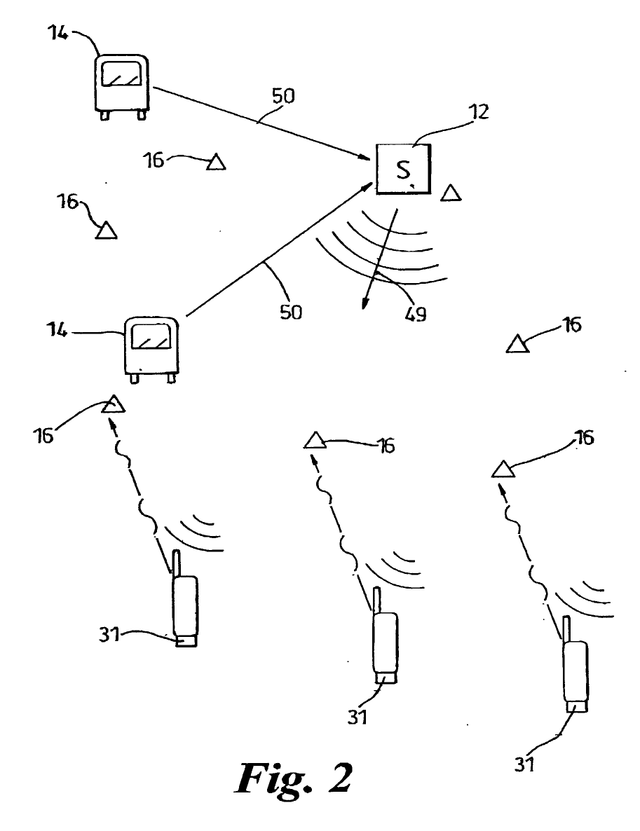

The processor 22 also receives present position signals, referenced as 50 in FIG. 2, from each bus. Each bus has its location finder 28 which sends a telecommunications signal indicative of the geolocation position of the bus to the control processor 22.

The present position signals may be sent substantially continuously from the buses, or periodically (for example every 10 or 20 seconds or so). The location finder 28 could be any suitable menu such as a GPS transponder, or possibly an inertial navigation system which monitors the direction of travel, speed, and time of travel of the bus and determines its position from dead reckoning. This latter option is preferred over GPS in some environments where the GPS signals may be blocked. It is possible for the bus inertial dead reckoning position finder to be recalibrated periodically upon receipt of a location identifying signal from a fixed beacon. For example some, or all, bus stops may have transponders which tell a bus that it is near them when it is near them. This could be used instead of dead reckoning or GPS: i.e. noting when a bus is near an earlier bus stop.

With a knowledge of the current position of the bus of interest, say bus number 9, and the position of the embarkation bus stop, the processor can evaluate a predicted time for the bus to reach the selected bus stop, with a knowledge of the expected speed of the bus. The processor can compare the expected time to arrival at the selected bus stop for the selected bus with the early warning notice period required by a user. When the two are equal, or nearly so within a predetermined margin, the control processor instigates the generation of a telecommunication advance warning signal 49, transmitted via the antenna 24, to the user's mobile phone 20.

This signal could result in an SMS early warning message being displayed, or an audio tone, or a voice message, or a vibration of the telephone, or any other way of sending an alert alarm to the user. The user may be able to select what type of alert message they want.

The antenna 24 may communicate directly with the buses, but more likely the communication will be via a telecomm network, such as via a cellular link, on a metropolitan area wireless network (possibly Bluetooth or 802.11).

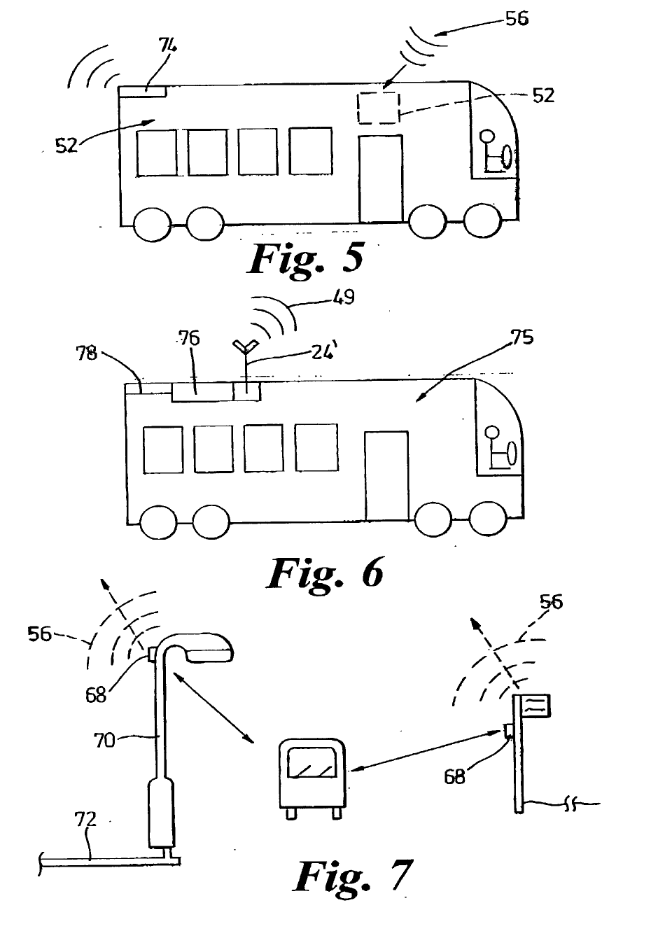

FIG. 5 shows a modification of the system. A bus 52 has a receiver 54 which receives vehicle position signals 56 from roadside transponders 68 (e.g. mounted on bus stop poles or street lights/lamp posts 70). Lamp posts and street lights (and other electrical street furniture) already have a power supply 72 for the transponder 68. The bus has a position output transponder 74 which communicates its position to the control processor 22. Alternatively the roadside transporters could note the proximity of the bus and they could communicate its position to the control processor.

FIG. 6 shows another modification in which a bus 75 which has an onboard control processor 76 and a position sensor 78. Instead of communicating its position to a central control processor the bus 75 has the database 23 on-board in its on-board processor 76 and emits advance warning signals, via an emitter 24, 49 to the user's mobile devices 20.

The mobile telephones 20 are monitored by a device position monitoring system, in this example a GPS system, but it could be an inertial system, a proximity to monitor beacon signal system, or a triangulation system, or indeed any suitable system. If a user 18 moves further away from a bus stop for which they have already entered a request for an early warning notification to the server 22, then whatever warning period they originally requested may or may not be enough time for them to reach the selected bus stop in time to reach the bus (e.g. a person could enter a 10 minute early warning period when they were 5 minutes walk away from the bus stop, and then walk a further x minute walk from the selected bus stop. Since the server 22 knows the position of the bus stop and the position of the user when they entered their “y” minutes warning, the server can estimate how much longer it would take a user to walk to the selected bus stop and automatically add that on to the notice period—giving an x+y minutes early warning notice to the user.

The server may be able to establish that the user is now, after moving (or indeed before moving), closer to another pick-up point for the bus and may inform the user of this, with the identity of the alternative pick up point.

The mobile device may be capable of displaying a map, or travel directions, to the user telling than how to get to the selected bus stop, and/or an alternative, possibly computer-selected, bus stop. This may be generated within-the mobile device, or at the base station control processor and transmitted to the mobile device. Other information may be displayed/displayable, such as the bus fare for the entered journey or the return timetable (and/or outward timetable). In the case of large bus stations (or train stations), for example, being the embarkation point, the platform number or bus stop number may be displayed (or other such identifier—a display of number is not necessarily essential, perhaps “Green Line”, or a representative of a green line (i.e. a colour) could be enough to identify a specific bus or train route).

In another embodiment the user can input the desired destination and the control processor, or mobile device, can inform them of the available transport routes and expected times of departure from appropriately local pick up points. This may not be restricted to the buses of one company, or even to one mode of transport. For example bus, train (overground and/or underground) and tram timetables may be available for analysis by the user or computer. Thus the system may not only provide an early warning, but also route planning/timetable information, and even computer-selected travel plans.

In another modification the user does not have to input a desired notice period to the system, and may not be asked to do so. Since the control processor knows the position of the selected bus stop and the position of the user (for example either from user-device position detecting, or because the user has elected to send the advance warning signal to a fixed, stationary, telecoms device) the control processor can estimate how long it will take the user to walk to the bus stop/location of the event being considered. The computer system can then automatically set the time of the advance notice alert signal. It may evaluate how long it predicts it will take a user to get to the desired location and add on a further short period for the comfort of the user.

It will be appreciate that although walking to the site of the event for which an advance notification has been discussed, it may be that the computer knows that the user will use some other mode of transport (e.g. bicycle, or car) and the journey-to-site time can be estimated accordingly. For example a user could input the event as being the landing of a particular airliner at a specific airport, (e.g. to meet someone off the plane) and the system could give an early warning by using advance knowledge of the progress of the aircraft, or even just from a knowledge of when it really took off, and could give the user advance notice a suitable time before predicted landing, perhaps allowing for driving to the airport and parking.

When a user is at a particular location the system could be informed, or learn, that extra time is needed to be added to its normal notice period. For example, in a large skyscraper it could take 5 minutes to leave the building, before the user even begins to walk to a bus stop or train station.

The control processor may know that certain geographical locations are associated with extra delays and so could, using the position of the user information, build in extra time in the warning notice period that is generated.

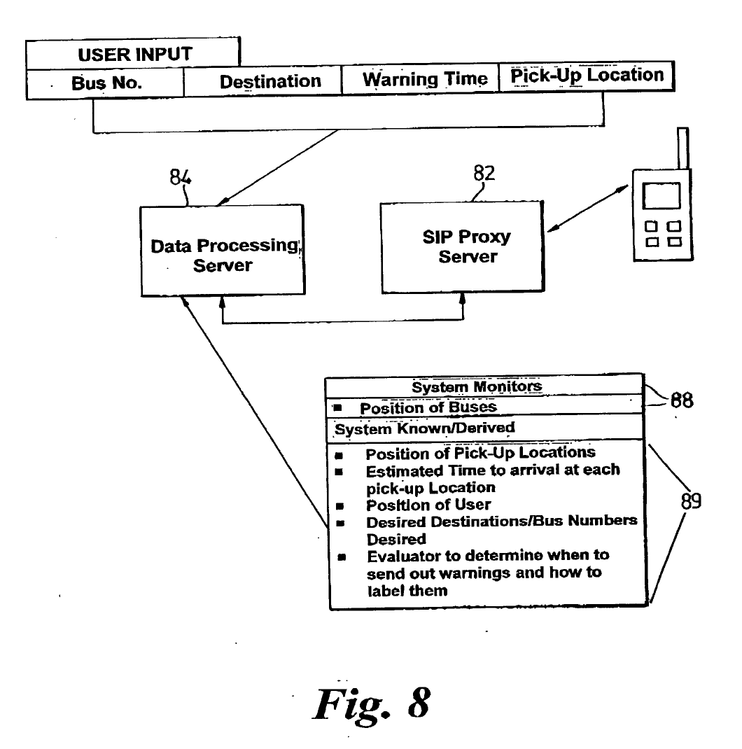

FIG. 8 shows a schematic representation of a control processor arrangement for use in a system similar to that of FIGS. 1 and 2. The control processor, or control server, referenced 80 in FIG. 8, comprises two servers: a telecommunication access server 82 which uses a Session Initiation Protocol (SIP) to access an external telecommunication network, (e.g. WAP), and a data processing control server 84 which receives inputs from the user (referenced 86) and inputs from automatically monitored things 88 (such as the position of a bus, weather and traffic conditions etc.) and produces early warning notification signals using inputs 86 and 88 and using system known/derived things 89.

The signals sent out from the system 80 to user's mobile devices (e.g. phones) are sent continuously using the telecasting technique. Instead of sending a separate message to each user, a single message (for a particular event, e.g. bus No. 9 arriving at University stop in 5 minutes) is sent and the message carries a header or flag identifying it as being of interest to a subclass of all possible users (i.e. the ones looking out for the event that is the No. 9 bus arriving at the University stop), and those devices which have a filter set appropriately will react to receipt of the telecast broadcast, and those that do not will not.

The system 80 sends out the signals continuously indicating for each bus route and each stop when a bus is within any of a number of time periods of the stop. For example signals will be sent out each time that a bus on route A is 5 minutes, 10 minutes, or 15 minutes from a particular stop, and corresponding signals will be sent out for other routes and other stops. Each signal gives a header or flag which indicates the bus route and the stop and the time to arrival. Each mobile phone or other suitable device which is set up to receive the signals indicates a filter which can be set by a user using the device's normal user input to filter out all signals except those carrying the flag for the route(s) and stop(s) of interest to and selected by the user. The device then produces an alarm when a signal relating to a selected stop and bus route is received but does not respond to the other signals. The alarm may be a single audible alarm and/or may indicate to the user, for example on a display of the device, the estimated time to arrival.

This arrangement has the advantage that the phone does not need to communicate anything to the Session Initiation Protocol server, and is particularly useful in urban areas, especially in a city centre where the number of users could be very high and the processing request from users could be difficult.

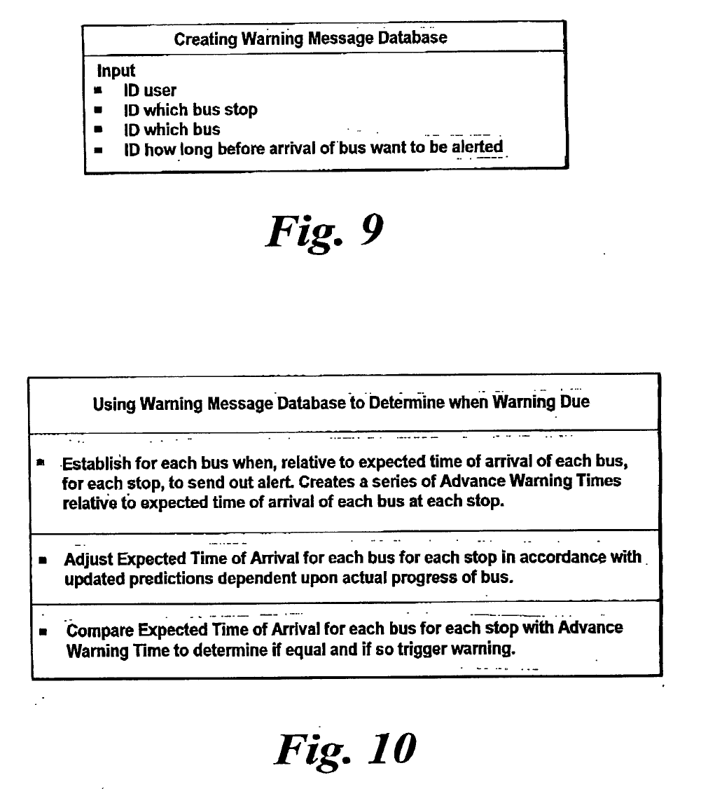

FIG. 9 schematically shows one embodiment of the inputs a user makes in order to set up an event notification request, and simultaneously set up a filter on their mobile device (a flag for which bus stop and which bus).

The user may be able to set up a threshold time or window before which or after which, he does not want to be notified. For example he may wish not to know about the event of the correct bus arriving at the correct bus stop all of the time—he may wish to spend a certain period free of alerts. For example, the user may set their request for an alert profile to be such that no alerts are requested before 5.00 p.m. This could be useful, for example, if the user wanted to spend a few hours at a meeting, or doing something, and did want to leave at the latest by a certain time to catch the bus but did not want to be interrupted too early before their deadline for leaving.

FIG. 10 shows schematically steps that a control processor similar to that of processor 22 in FIG. 1 may go through.

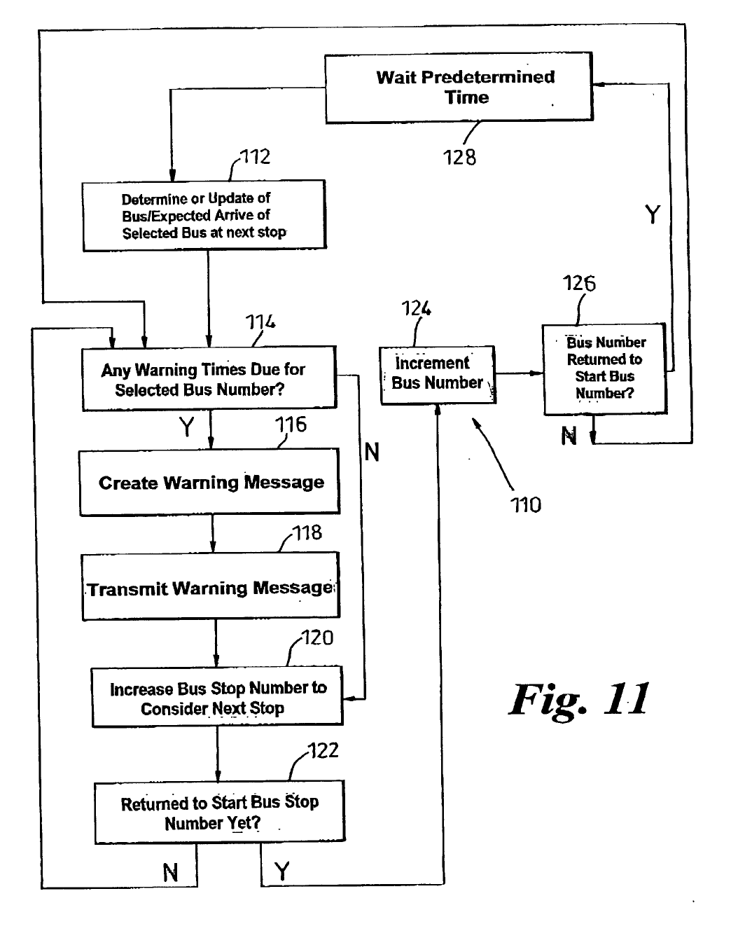

FIG. 11 shows a flow chart for a software routine 110 running in a control processor such as that of processor 22 of FIG. 1. For each bus the routine determines at 112, or updates, the expected times of arrival of the selected bus (e.g. bus id abfgh 14 operating on route number 9) at its next scheduled bus stop and indeed all of its scheduled stops.

At 114 the routine checks to see if there are any requests awaiting fulfilment for advance notice of that bus arriving at the next bus stop (the system knows where the bus is and so knows what is its next stop). If there is an unfulfilled request the system creates a warning message at 116 and transmits it at 118.

The system then increases the bus stop number being considered 120 i.e. it moves on to consider the next bus stop and returning to routine 114 after checking at stop 122 that it has not returned to the start bus stop I.D.

It will be appreciated that instead of cycling through each bus stop on the selected route starting with the next stop that the bus will reach, the system could start at the same stop each time (e.g. stop number one), and not care, for this purpose, where the bus is located. It will cycle through the available bus stop for the selected bus very fast in any case.

Once all of the available bus stops have been evaluated the system increments the bus being considered to the next bus, shown as 122 in FIG. 11. There may be another bus operating the same route, or it may be a bus on a different route.

The system checks at routine 126 that the bus identification number has not returned to the start bus I.D. number, and if not proceeds to routine 114 again, but for a different bus than previously.

If the route 110 has cycled through all available bus identifications (and hence all buses for all allowable stops have been considered) the routine waits a while (step 128), for example 10 seconds or 20 seconds, and then starts again at routine 114 with an initial bus I.D. and an initial bus stop id.

It will be appreciated that the system could cycle through the available buses first and then the bus stops (the opposite way around to that described above), or, indeed may not cycle in any logical sequence, but could simply check all buses and stops in any order.

It will be appreciated that instead of creating warnings as they are needed the system could create them in advance and release them when the expected time of arrival of a selected bus at a selected stop matches the advance notice period.

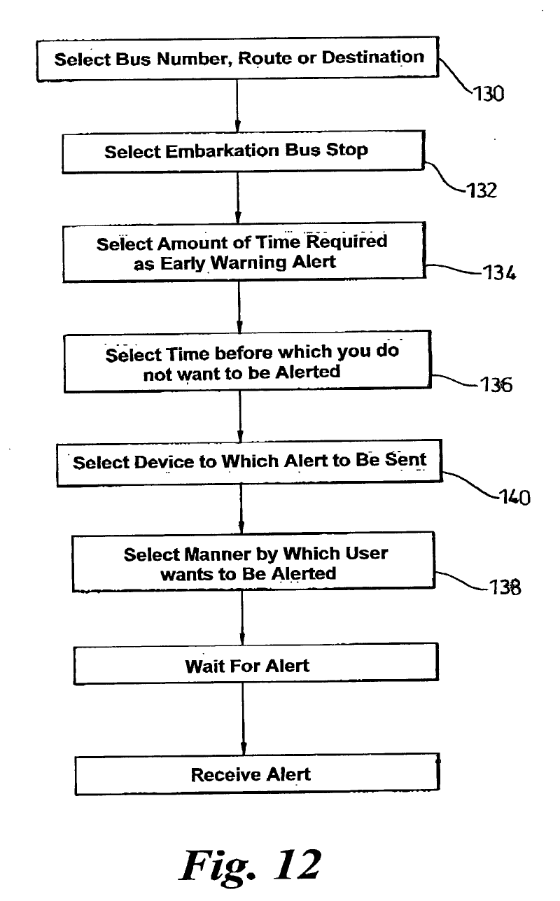

FIG. 12 illustrates one particular request for advance notice alert set up routine for a user. A user selects at 130 a bus route, or a destination (or both), selects at 132 an embarkation bus stop, selects at 134 a notice period required as advance notice of the bus arriving, selects at 136 a threshold time before which an alert is not desired, selects at 138 the device to which they wait the alert to be sent (e.g. the mobile phone, or other device making the request, another mobile phone or mobile device, a selected land-line telephone, a selected PC), and at 140 they select the manner in which they wish to be alerted (e.g. SMS message, audio—e.g. beep or buzzer, voice message, visually—e.g. flashing light or a display message/indication on a screen, by vibration, by e-mail etc).

The control processor may be able to check that the transmitted early warning notification message, e.g. signal 49 in FIG. 2 was received by the user's device (e.g. by the device acknowledging receipt/acknowledging a telecoms link). If the control processor does not receive this confirmation of receipt it may re-send the message, possibly periodically up to a set limit (e.g. limit in time, or limit in number of attempts).

A user may be able to elect to have an alert sent to more than one telecom address.

It will be appreciated that by monitoring a parameter that is associated with the arrival of a specified event (e.g. a specific type of bus arriving at a specific stop) advance notifications that are more meaningful than simply pre-planned scheduled event warnings can be achieved. The monitored parameter is preferably representative of a real physical thing (e.g. the position of a vehicle).

Of course, instead of pressing keys on a device to input data a user could talk into the device if it is configured for speech recognition.

In one example, the invention may comprise a vehicle arrival (or event notification) system which does not monitor the position of the vehicle, but instead varies the timing of the sending out of alert signals dependent upon how far away a user is from the vehicle meeting/pick up point. However, in the vast majority of applications it will be appropriate to monitor the progress of the vehicle in some way.

In one specific example the application will use the Session Initiation Protocol to send and receive the alert signals. A device installed in a bus will compute the exact position of the bus using GPS or by using the speed of the vehicle, a compass and a map. When the bus reaches any preprogrammed position, the device will send the signal using a multicast mode. The multicast address is function of the distance or the time between the user(s) and the bus stop. All these signals can also be sent from the bus station, which tracks all the buses.

The user can choose any bus depending on the destination and ask the Session Initiation Protocol server to filter all the other signals except the one concerning the bus he intend to take. It will be possible to send the signal on the phone.

As suggested above, in some embodiments a vehicle may communicate its presence/position to a base station when it reaches predetermined physical locations, instead of a set point in time. For example, each time a bus or train reaches a bus stop or station it may communicate its position to the base station.

Session Initiation Protocol is important to some aspects of the invention. It is application layer software (in the OSI model). It is easy to install on processors. Some existing processors, for example of cellular telephones or PDA's, are configured to allow retrofitting of Session Initiation Protocol telecommunications software, possibly remotely. More typically we envisage mobile general purpose telecommunications devices, such as telephones, PDA's laptops etc., being factory configured to enable Session Initiation Protocol telecommunications. It is then a matter of loading the specific application software to those mobile devices to enable them to receive/recognise alert signals as being for them. It may also be usual for us to load software onto the devices to enable them to input information to a base station/alert generator server and/or to enable them to have user-set filters.

In one embodiment a central Session Initiation Protocol enabled server emits signals detailing the expected arrival times of all vehicles known to it at their next stop (or stops) and users set the filter on their portable devices to alert them only to the events of interest.

The event detection/recognition software and/or the filter-setting software may be downloaded at the point/time of use (wirelessly) by a user, and may have a limited duration when it is operable or limited usage conditions. For example, the downloaded software may only be good for a single day, or week, or period, or it may be good for a set number of alerts to the user. In this way the transport company and/or the telecommunications company and/or the device-controlling company may be able to access an on-going income if they make users pay for access to the enabling software.

One Session Initiation Protocol is chosen as the telecommunications platform it is not too difficult to convey software solutions to the mobile telecoms devices, and not difficult to change things. For example, the Session Initiation Protocol-enabled multicast signals may be code-protected, and the code may change from time to time, and the user may have to pay for access to new codes to access the signals/decode them.

Session Initiation Protocol is a light protocol that is easily downloaded. It operates in real time. It has applications typically in voice-over-IP, but we have realised that it is suitable for our purposes. It is suitable for copying short messages similar to SMS messages, but via an IP network.

Session Initiation Protocol allows the establishment of a real time application software running to monitor broadcast messages and/or vehicle positions.

Session Initiation Protocol has multi-user facilities—so more than one user can input and receive data. This is, of course, useful with many vehicles inputting their position and many passengers wanting to know when they will arrive.

We envisage not only one kind of transport vehicle having their arrival times alertable to a user: different kinds of vehicle may have their schedules altertable. For example trains and buses (and indeed aircraft, ships etc.) may be covered. A user may be able to select between the type of vehicle whose movements are required.

In one embodiment a user may not specify which route or which stop they want, just their destination, and the system may report possible options to them. The user may select one preferred event (vehicle-at-stop) or more than one, about which they want to be alerted in the future.

The software loadable onto the portable device may also enable the device to display the location of a stop (e.g. a map), or a plurality of stops, and may also enable the device to display the position of the user (e.g. on the map).

As discussed, the impromptu downloading of appropriate event-notification software is used when a user decides they would like to be notified of an event is envisaged. A user does not therefore have to choose to buy a device with the specific application software loaded on it, or to subscribe in advance (days or weeks in advance) to a service: they just dial up and download there and then (possibly incurring a cost/fee).

Other options can be added: extra/different functionality can readily be loaded in the future, for example using Session Initiation Protocol telecoms. This somewhat “future proofs” the portable device—but it does require the device to have appropriate processing capability and hardware/firmware.

It is also possible for a user to uninstall the event-notification software from their device (or for it to cause itself to be uninstalled (or blocked) at a future time/event.

The portable user device may be battery powered, with replaceable batteries, and may be “pocketable” (small enough to be put into a normal trouser or jacket pocket.

The device may telecommunicate at a frequency of the order of about 1 GHz

It will be appreciated that many embodiments of the invention use a general purpose mobile telecommunication device to input and/or receive signals relating to the selection of the location (e.g. bus stop) and/or advance notice time, and/or bus route/number, and/or the advance notice warning signal itself. For example, there are already millions and millions of mobile telephones (satellite and even more common cellular phones). They are well suited to inputting/receiving signals, especially using Session Initiation Protocol techniques. Indeed, it may not be necessary to implement hardware changes in existing mobile telephones to implement the invention: software changes may be all that is required, especially with those mobile phones that have a display. Such software changes may be achieved wirelessly: i.e. software could be telecommunicated to the mobile telephones (depending upon the capabilities of the CPU chip in the mobile phone). Thus retro-fitting the functionality discussed to existing mobile phones is conceivable, especially using Session Initiation Protocol.

Other general purpose wireless telecommunications devices can be configured as receivers/input devices, such as PDA's or palm computers. Many portable internet-accessing devices now exist which could be suitable.

Even if the CPU chip of an existing device is not configured to allow wireless software changes, it is straightforward to manufacture new devices with the requisite software to perform as discussed.

By “general purpose” wireless telecommunications device is meant a device that has functionality beyond simply the impending event notification and/or input of registration/notice period information functionality discussed. For example a “general purpose” device may allow voice communication (e.g. mobile telephone) or text communication (e.g. PDA with internet access/e-mail capability), or both voice and text, or multimedia: more than a dedicated single-use device.

We claim:

1. A method of alerting a user to the expected occurrence of an event and of automatically providing the user with a predetermined notice period of the expected occurrence of the event, the method comprising:
identifying an event which has an unreliable start time, but a start time that can be predicted more accurately as the time of said event approaches by monitoring a precursor parameter to said event;
predicting from monitoring the precursor parameter when said event is likely to take place;
automatically issuing advance notice that said event is expected to take place, said advance notice being issued a predetermined notice period before the expected time of said event and using Session Initiation Protocol to communicate said advance notice.

2. A method according to claim 1 wherein signals representative of the precursor parameter are transmitted to a Session Initiation Protocol server which issues said advance notice using Session Initiation Protocol telecommunications.

3. A method according to claim 2 in which said Session Initiation Protocol server accesses a database correlating user selected events with an output of corresponding telecast Session Initiation Protocol telecommunications signals.

4. A method according to claim 1 wherein said advance notice is telecast by a telecast emitter, and a user has a receiver which selects those telecast emissions that are recognised as being of interest in order to trigger said advance notice.

5. A method according to claims 1 further comprising communicating an application level software program to a receiver device to enable said receiver device to react to said advance notice, said software being communicated to said receiver device via wireless telecommunications.

6. A method according to claim 5 wherein said advance notice is issued to a hand-holdable mobile wireless portable general purpose telecommunications device via electronic wireless telecommunications.

7. A method according to claim 1 wherein a user selects a time threshold outside of which said advance notice is not to be brought to their attention.

8. A method according to claim 7 in which a user selects one of:
(i) an approximate time;
(ii) time window; and
(iii) time threshold;
in order to receive advance notice of occurrence of said event if the event is expect to occur at one of:
(i) said approximate time, (ii) within said selected time window; and
(iii) within said time threshold.

9. A method according to claim 1 wherein said event comprises arrival of a vehicle at a specified location and wherein said precursor parameter is, or is evaluated using, the position of said vehicle.

10. A method according to claim 1 wherein a user selects the length of time they require as advance notice of the event and inputs it to an event monitoring processor using a hand-holdable mobile wireless portable general purpose telecommunications device.

11. A method according to claim 10 in which the input of the length of time of advance notice is communicated from the device using Session Initiation Protocol telecommunications.

12. A method according to claim 1 comprising transmitting an advance notice signal to a plurality of users simultaneously, or substantially simultaneously.

13. A method according to claim 12 comprising having a flag associated with a broadcast signal and having a user device recognise flags which are associated with events for which it is intended to provide an advance notice warning to its user.

14. A method according to claim 13 wherein the user uses a hand-holdable mobile wireless portable general purpose telecommunications device to set a filter on the telecommunications device themselves.

15. A method according to claim 1 further comprising monitoring the position of a user and modifying the timing of said alert notice dependent upon the position of the user and/or the distance of the user from a specific location at which said event will take place.

16. A method according to claim 15 in which the timing of the alert notice is dependent upon the location of the user, some locations having different notification-modifying effects even though they are the same distance from the event location.

17. A method of alerting a user of the approach of a vehicle comprising:
having details of the identity of at least one vehicle, the stops that it is intended to make, and the amount of time required for an advance warning to the user notifying them that a vehicle is due at a selected stop;
monitoring the position of the or each vehicle;
predicting how long it will take the or each vehicle to reach the or each vehicle stop using the present position of the vehicle information;
determining when the vehicle reaches a distance from the stop predicted to take substantially the same time as the required advance warning time; and
alerting the user to the approach of the vehicle when the expected time for it to travel to the stop is substantially the same as the required advance warning time;
and wherein the user is alerted by a Session Initiation Protocol telecommunications signal.

18. A method according to claim 17 comprising communicating said alert signal from a Session Initiation Protocol server at a base station.

19. A method according to claim 17 wherein the or each vehicle communicates its location to a control processor which uses the location of the or each vehicle to establish an alert sent to the user that a specified vehicle is coming.

20. A method according to claims 17 further comprising the user communicating to an alert generator at least one of:
(i) the identity of the vehicle stop at which they wish to meet the vehicle;
(ii) the approximate time at which they wish to meet the vehicle;
(iii) the identity of the vehicle they wish to meet and/or the route and/or the user's of the vehicles destination;
(iv) the amount of notice time they would like to have as an early warning that the vehicle is due for arrival at the vehicle stop.

21. A method according to claim 20 wherein the user inputs all four of (i) to (iv).

22. A method according to claim 20 wherein the user communicates with the alert generator via Session Initiation Protocol telecommunications.

23. A method according to claim 21 comprising providing a user with a portable general purpose telecommunications device which filters out, or does not react to, received signals relating to non-selected vehicles and which only alerts the user to events relating to a selected vehicle or vehicles.

24. A method according to claim 23 wherein the user inputs the selection of which vehicle is of interest using the same device which alerts them to the impending arrival of the vehicle.

25. A system adapted to provide an early warning alert to a user of the expected occurrence of an event, the system comprising:
a notice alert generator adapted to generate an alert notice;
a user-operated input device adapted to input a request for a notice alert to be sent;
an alert notice emitter adapted to emit an alert notice signal;
an alert notice detector adapted to detect an alert notice signal;
a user alarm adapted to produce a user-noticeable alert alarm;
the arrangement being such that in use the user is capable of requesting a notice alert using the input device, the alert notice generator, in use, receiving the alert notice request and producing an alert notice in response to the request, the alert notice being emitted by the emitter and detected by the detector, thereby causing the user to be alerted; and wherein the alert notice is communicated to the user using Session Initiation Protocol telecommunications.

26. A system according to claim 25 in which the alert notice detector and the user alarm are provided on a user's portable hand-carriable wireless general purpose telecommunications device with a Session Initiation Protocol enabled processor.

27. Software which when running on a processor adapted to output Session Initiation Protocol telecommunications signals and configured to function as an advance notice alert generator, takes as input parameters: a selected event; a precursor parameter related to said selected event to enable the timing of said selected event to be predicted; and a notice period length of time representative of an amount of time before said selected event a user is to be informed of the impending arrival of the event; and which operates on the inputs to generate a Session Initiation Protocol alert signal at a time before said predicted event that is predicted to be said notice period before said event is expected to take place, and to output said Session Initiation Protocol alert signal to a telecommunication transmitter.

28. Software according to claim 27 adapted to label said notice alert signal with a flag to enable those users who have elected to receive signals carrying that flag to identify said notice alert signal as a desired, flagged, signal.

29. Software which when running upon a processor enables the processor to generate an output signal representative of at least one of:
(i) a user-selected advance notice alert period;
(ii) an event-identifying label or signal;
(iii) an event timing label or signal;
(iv) an address to receive an alert label or signal;
said output signal being configured to be compatible with Session Initiation Protocol telecommunications.

30. Software according to claim 29 which includes a user-device movement compensatory function which evaluates whether the user device has moved significantly geographically after a request for an alert warning signal has been transmitted by the user device, and if so causes an updated/modified advance warning period to be set to take into account the movement of the user.

31. A server having a control processor and a database, the database having details of the addresses of user devices, the location of an event site, an early warning alert period that it is intended to give to users as an early warning of the expected arrival of respective selected events; and
the processor having access to event alert notice generator software which has as an input an event precursor parameter which changes as the event approaches in time, and wherein the processor is adapted to use the event alert notice generator software to process the event precursor parameter in conjunction with the data in the database to generate an alert advance notice signal at a time that is predicted to be the desired notice period before the event is expected to occur, the alert advance notice signal being generated in a form communicatable with a remote device using Session Initiation Protocol telecommunications.

32. A computer readable memory device encoded with a data structure for generating advance notice of an impending event, the data structure having entries, each entry containing a first parameter value corresponding to the telecommunication address of each user, a second parameter value corresponding to the chosen event for which each user wishes to receive advance notice, and a third parameter value corresponding to the amount of advance notice time each use requires.

33. A hand held portable wireless general purpose telecommunications device enabled for Session Initiation Protocol telecommunications, the device having a control processor, a transmitter and receiver, a data input structure, and a program store; the data input structure allowing data to be input into said device, and said control processor having access to an event notification program stored on said program store, said event notification program being adapted to prompt for, in use, the input of data relating to one or more of:
(i) the identity of an event for which advance notice is required;
(ii) the amount of time required as advance notice.

34. A hand held device according to claim 33 which is adapted to emit a signal containing the input prompted data.

35. A device according to claim 33 which has a position sensor and which is adapted to include in said emitted signal data relating to its position.

36. A device according to claim 35 which comprises one of:
(i) a mobile telephone;
(ii) a personal digital assistant with wireless telecommunications capability; and
(iii) a palm or laptop computer with wireless telecommunications capability.

37. A method of alerting a user to the expected occurrence of an event and of automatically providing the user with a predetermined notice period of the expected occurrence of the event, the method comprising:
identifying an event which has an unreliable start time, but a start time that can be predicted more accurately as the time of the event approaches by monitoring a precursor parameter to the event;
predicting from the monitoring of the precursor parameter when the event is likely to take place;
automatically issuing advance notice that the event is expected to take place, the advance notice being issued a predetermined notice period before the expected time of the event; and the advance notice being issued via wireless telecommunications to a hand-holdable portable wireless general purpose telecommunications device.

38. A method according to claim 37 in which the precursor parameter is monitored in real time and the advance notice is issued in real time consequential to the monitoring of the precursor parameter.

39. A method according to claim 37 wherein said event comprises the arrival of a vehicle at a specified location and wherein said precursor parameter is, or is evaluated using, the position of said vehicle.

40. A method according to claim 38 wherein said advance notice is issued and/or received using application level notice-receiving software residing upon an emitter and/or receiver device.

41. A method according to claim 40 wherein said notice-receiving software is loaded onto a receiver device remotely to enable said receiver device to receive said advance notice.

42. A method according to claim 41 wherein said software is transmitted to the receiver device using Session Initiation Protocol telecommunications.

43. A method according to claim 37 wherein said advance notice is issued and received using Session Initiation Protocol telecommunications.

44. A method according to claim 40 wherein said notice receiving software has a time-limited useful life on a receiver device.

45. A method according to claim 37 wherein said signals representative of the precursor parameter are transmitted to a Session Initiating Protocol Server which issues said advance notice using Session Initiation Protocol telecommunications.

46. A method according to claim 37 wherein said advance notice is telecast by a telecast emitter, and a user has a receiver which selects those telecast emissions that are recognised as being of interest in order to trigger the advance notice.

47. A method according to claim 37 in which a user uses said hand-holdable mobile wireless portable general purpose telecommunications device to set a filter on the telecommunications device themselves, the filter recognising notices that are to be announced to the user.

48. A method of alerting a user of the approach of a vehicle comprising:
having details of the identity of at least one vehicle, the stops that it is intended to make, and the amount of time required for an advance warning to the user notifying them that a vehicle is due at a selected stop;
monitoring the position of the or each vehicle;
predicting how long it will take the or each vehicle to reach the or each vehicle stop using the present position of the vehicle information;
determining when the vehicle reaches a distance from the stop predicted to take substantially the same time as the required advance warning time, and
alerting the user to the approach of the vehicle when the expected time for it to travel to the stop is substantially the same as the required advance warning time by sending a telecommunications signal to a hand-holdable portable general purpose wireless telecommunications device.

49. A method according to claim 48 further comprising the user communicating to an alert generator using the general purpose wireless telecommunications device at least one of:
(i) the identity of the vehicle stop at which they wish to meet the vehicle;
(ii) the approximate time at which they wish to meet the vehicle;
(iii) the identity of the vehicle they wish to meet and/or the route and/or the users of the vehicles destination;
(iv) the amount of notice time they would like to have as an early warning that the vehicle is due for arrival at the vehicle stop.

50. A method according to claim 49 wherein said device is a hand-held portable wireless telecommunication device.

51. A system adapted to provide an early warning alert to a user of the expected occurrence of an event, the system comprising:
a notice alert generator adapted to generate an alert notice;
and a portable hand holdable general purpose wireless telecommunications device which comprises an alert notice detector adapted to detect the alert notice and to emit an alert notice signal; and
a user alarm adapted to produce a user-noticeable alert alarm;
the arrangement being such that in use the alert notice generator produces an alert notice, the alert notice being emitted by the emitter and detected by the device, thereby causing the user to be alerted.

52. A system according to claim 51 in which the device comprises a cellular telephone.

53. A system adapted to provide an early warning alert to a user of the expected occurrence of an event, the system comprising:
a notice alert generator adapted to generate an alert notice; and
a telecommunications device which comprises an alert notice detector adapted to detect the alert notice and to emit an alert notice signal; and
a user alarm adapted to produce a user-noticeable alert alarm;
the arrangement being such that in use the alert notice generator produces an alert notice, the alert notice being emitted by the emitter and detected by the device, thereby causing the user to be alerted;
wherein the alert notice is communicated to the device using Session Initiation Protocol telecommunications.

54. A system according to claim 53 in which the device comprises a cellular telephone.

55. Software loadable upon a processor of a general purpose wireless mobile telecommunications device which when running upon the processor enables the processor to generate a signal representative of at least one of:
(i) a user-selected advance notice alert period;
(ii) an event-identifying label or signal;
(iii) an event timing label or signal;
(iv) an address to receive an alert label or signal;

56. A hand held portable wireless general purpose telecommunications device having a control processor, a transmitter and receiver, a data input structure, and a program store; the data input structure allowing data to be input into the device, and the control processor having access to an event notification program stored on the program store, the event notification program being adapted to prompt for, in use, the input of data relating to one or more of:
(i) the identity of an event for which advance notice is required;
(ii) the amount of time required as advance notice.

57. A device according to claim 53 which has a position sensor and which is adapted to include in the emitted signal data relating to its position.

58. A method of enabling a Session Initiation Protocol-enabled general purpose mobile wireless telecommunications device to provide advance warning of an event comprising running on a processor of the device software which detects advance warning signals transmitted using Session Initiation Protocol telecommunications and alerts a user.

59. A method according to claim 58 further comprising loading said software onto the device using wireless telecommunications.

60. A method according to claim 59 comprising impromptu loading of the software at a time of need, as opposed to pre-loading the software with forethought.

61. A method of providing an added value software application on a portable telecommunications device comprising:
providing a portable telecommunications device arranged to receive advance warning signals relating to respective events, and provide advance warning to a user;
providing application level software;
wirelessly communicating the software to the device;
charging for at least one of the use of and downloading of the software; and
wherein the software filters received advance warning signals to identify advance warning signals relating to a selected event of interest to a user and non-selected events not of interest to the user, and
provides the advance warning of said selected event but not of said non-selected events;
wherein the advance warning signal is communicated using Session Initiation Protocol telecommunications.

62. A method of providing an added value software application on a portable telecommunications device comprising:
providing a portable telecommunications device arranged to receive advance warning signals relating to respective events, and provide advance warning to a user;
providing the application level software;
wirelessly communicating the software to the device;
charging for at least one of the use of and downloading of the software; and
wherein the software communicates to a main server a request for advance warning of a selected event of interest to a user and receives from the main server in response to said request an advance warning signal giving advance warning of the selected event; and
provides the advance warning of the selected event to a user;
wherein the device is a hand held portable wireless general purpose telecommunications device.

63. A method of providing an added value software application on a portable telecommunications device comprising:
providing a portable telecommunications device arranged to receive advance warning signals relating to respective events, and provide advance warning to a user;
the application level software;
wirelessly communicating the software to the device;
charging for at least one of the use of and downloading of the software; and
wherein the software filters received advance warning signals to identify advance warning signals relating to a selected event of interest to a user and non-selected events not of interest to the user, and
provide the advance warning of said selected event but not of said non-selected events;
wherein the device is a hand held portable wireless general purpose telecommunications device.

64. A method of providing an added value software application on a portable telecommunications device comprising:
providing a portable telecommunications device arranged to receive advance warning signals relating to respective events, and provide advance warning to a user;
the application level software;
wirelessly communicating the software to the device;
charging for at least one of the use of and downloading of the software; and
wherein the software communicates to a main server a request for advance warning of a related event of interest to a user and receives from the main server in response to said request an advance warning signal giving advance warning of the selected event; and
provides the advance warning of the selected event to a user;
wherein the advance warning signal is communicated using Session Initiation Protocol telecommunications.

65. A general purpose mobile hand-holdable wireless telecommunications device having a processor enabled to communicate using Session Initiation Protocol, and having in memory an event advance notification application software, said software when running on said processor causing said processor to control said device to enable said device to identify and screen out filter-matching advance notice signals received using Session Initiation Protocol telecommunications from all advance notice signals received by said device, and to cause said device to warn a user of the receipt of a filter-matching advance notice signal, said device having a user-set filter configurable by said user to distinguish those filter-matching advance notice signals that are at the choice of the user to be used as trigger to warn a user, from those non filter-matching signals that are not to be used to trigger a warning for the user.

66. A general purpose mobile hand-holdable wireless telecommunications device having a processor configured to enable the device to communicate using Session Initiation Protocol, and having in memory an application level program which when run on the processor causes the device to enable a user to determine the identity of at least one of:
a vehicle route, a stop location of interest, and a notice period desired, and to monitor Session Initiation Protocol telecommunications signals representative of the expected time of arrival of a vehicle of a selected route at a selected stop in order to cause said device to give an advance warning to the user of the impending arrival of said vehicle at said stop.

67. A general purpose mobile hand-holdable wireless telecommunications device having a processor configured to enable the device to communicate using Session Initiation Protocol, and having in memory an application level program which when run on the processor causes the device to enable a user to determine the identity of at least one of a vehicle route, a stop location of interest, and a notice period desired; and to monitor Session Initiation Protocol telecommunications signals representative of the expected time of arrival of a vehicle of a selected route at a selected stop in order to cause said device to give an advance warning to the user of the impending arrival of said vehicle at said stop; and wherein said software enables said device to transmit information relating to at least one of said selected vehicle, said stop, and said desired notice period, via Session Initiation Protocol telecommunications to a remote vehicle-arriving warning transmission station.

68. A method of increasing the functionality of a mobile telephone comprising loading upon it software which enables it to be used automatically to alert a user to the impending arrival of a vehicle at a stop point by configuring said telephone to respond to selected wireless transmitted advance notice of vehicle arrival signals.

69. A method of increasing the functionality of a mobile telephone comprising loading upon it software which enables it to be used automatically to alert a user to the impending arrival of a vehicle at a stop point by configuring said telephone to respond to selected wireless transmitted advance notice of vehicle arrival signals; the loaded software also enabling the user to determine those vehicle arrival events that they wish to be warned of, so as to enable the telephone to distinguish between vehicle arrival events for which the user does wish to be given advance notice, and those for which the user does not wish to be given advance notice.

70. A method of increasing the functionality of a mobile telephone comprising loading upon it software which enables it to be used automatically to alert a user to the impending arrival of a vehicle at a stop point by configuring said telephone to respond to selected wireless transmitted advance notice of vehicle arrival signals, and wherein the signals are transmitted using Session Initiation Protocol telecommunications.

71. A method of increasing the functionality of a mobile telephone comprising loading upon it software which enables it to be used automatically to alert a user to the impending arrival of a vehicle at a stop point by configuring said telephone to respond to selected wireless transmitted advance notice of vehicle arrival signals; the loaded software also enabling the user to determine those vehicle arrival events that they wish to be warned of, so as to enable the telephone to distinguish between vehicle arrival events for which the user does wish to be given advance notice, and those for which the user does not wish to be given advance notice, and wherein the signals are transmitted using Session Initiation Protocol telecmmunications.
